(19) United States
(12) Patent Application Publication
(10) Pub. No.: US 2007/0197263 A1
(43) Pub. Date: Aug. 23, 2007

(54) Handsfree Kit For A Mobile Telephone

(76) Inventor: Ole Magleby Gudmand-Hoyer, Gentofte (DK)

Correspondence Address: ALTERA LAW GROUP, LLC, 6500 CITY WEST PARKWAY, SUITE 100, MINNEAPOLIS, MN, 55344-7704, US

(21) Appl. No.: 10/572,774

(22) PCT Filed: Sep. 21, 2004
(86) PCT No.: PCT/DK04/00640

§ 371 Date: Oct. 23, 2006

(30) Foreign Application Priority Data
Sep. 24, 2003 (DK) PA 2003 01387
Jan. 13, 2004 (DK) PA 2004 00030

(51) Int. Cl. H04M 1/00

(52) U.S. Cl. 455/569.1

(57) ABSTRACT

A handsfree kit for a mobile telephone uses RDS signals for transferring calls to the loudspeaker of a car radio, as a circuit comprising an RDS generating circuit has an antenna output for connection to the antenna input of the car radio, said circuit having an antenna input which is connected to an external antenna. A prioritizing circuit is arranged in the circuit, so that RDS signals transferring calls to the car radio always have to priority, while other signals have a lower priority. The RDS signals are also transferred when the car radio is switched off. The circuit moreover contains a switching circuit so that calls may be switched between the car radio and a headset, which may expediently be connected to the handsfree kit via a Bluetooth communications link. The invention provides a mobile, handsfree kit which is easy to install in a car, in particular subsequently, as the coupling to the car radio takes place by coupling the circuit to the antenna connector of the car radio, while the external radio antenna of the car is coupled to an antenna input of the circuit.

The invention relates to a handsfree kit for a mobile telephone and comprising a circuit coupled between the mobile telephone and a car radio having a loudspeaker, said circuit being adapted to transfer information from the mobile telephone to the loudspeaker of the car radio at a call to the mobile telephone, irrespective of whether the car radio is in an active or a passive state, said circuit comprising an RDS generating circuit which is connected via an antenna connector to an antenna input of the car radio.

With the desire of reducing the risk of accidents caused by distraction because mobile telephone users use their mobile telephones when making a call and answering a call with their hands while driving a car, the so-called handsfree telephone kits are offered today, where the users can let the mobile telephone remain in a telephone holder and still conduct a conversation, as the mobile telephone is coupled to the loudspeaker of a car radio.

In addition, a microphone, which is connected to the mobile telephone, may be arranged in the vicinity of the user's head, e.g. in the ceiling of the car.

Generally, these systems have to be installed subsequently and are moreover of a quite complicated structure and are not very flexible, since e.g. an exchange of a mobile telephone to another model or another make may mean that the entire handsfree kit has to be exchanged.

Therefore, it has been attempted to manufacture more flexible and simple handsfree kits, but with the same comfort as the complicated kits. An example of such a less complicated and flexible handsfree kit is known e.g. from the description of the published EP Patent Application No. 920 170 A2, where a mobile telephone uses RDS signals to pass a call to the mobile telephone further on to the mobile radio.

The above-mentioned systems operate such that as soon as a call is made to the mobile telephone, the car radio, and perhaps its extra units, such as cassette player or CD, will be switched off. Further, a call may be received even if the car radio and its extra units are switched off.

The advantage of such a handsfree kit is that the mobile telephone may be operated while it is seated in the holder, and furthermore that a call to or from the mobile telephone has priority over the reception of radio signals by the car radio.

Thus, prioritization of calls to or from the mobile telephone is carried out, which is desirable precisely in connection with the use of mobile telephones in cars.

It is not disclosed or suggested in the above-mentioned EP publication what takes place if a call is made to the mobile telephone during the reception of an RDS signal which arrives as a traffic message.

Accordingly, an object of the invention is to provide a handsfree kit in which RDS signals originating from mobile telephone calls have priority.

The object of the invention is achieved by a handsfree kit of the type defined in the introductory portion of claim 1, which is characterized in that a prioritizing circuit is arranged in the RDS generating circuit, so that information transferred to the loudspeaker of the car radio is prioritized such that an RSD signal containing a call to the mobile telephone always has top priority.

It is ensured in this manner that the mobile telephone always has top priority, which is very important to some individuals.

In other words, conflicts between the types of signals transferred to the mobile telephone are avoided, which ensures that a user does not try to answer a call by removing his mobile telephone from its telephone holder.

To ensure this prioritization, it is an advantage if, as stated in claim 2, the RDS generating circuit has an antenna input for the connection of an external antenna, whereby RDS signals concerning traffic messages or the like may be captured in the RDS generating circuit and be given priority there.

Expediently, as stated in claim 3, the circuit additionally has a control circuit which is coupled via an input to a switch for switching the calls of the mobile telephone between the car radio and a headset, thus achieving the advantage that calls of a private nature may rapidly be switched from the loudspeaker of the car radio to the headset.

When, as stated in claim 4, the headset is connected to the circuit via a short range communications link, such as Bluetooth, it is ensured that mobile telephones not already intended for the use of headsets with Bluetooth technology may now be used with Bluetooth technology.

With a view to achieving easy coupling of a handsfree kit according to the invention to any given mobile telephone, irrespective of model or make, it is an advantage if, as stated in claim 5, the circuit contains an interface circuit which is connected to the mobile telephone through a mobile telephone holder.

This easy coupling is ensured additionally if, as stated in claim 6, the interface circuit is connected to the mobile telephone holder via a short range communications link, such as of the Bluetooth type.

The invention will now be explained more fully with reference to the drawing, in which:

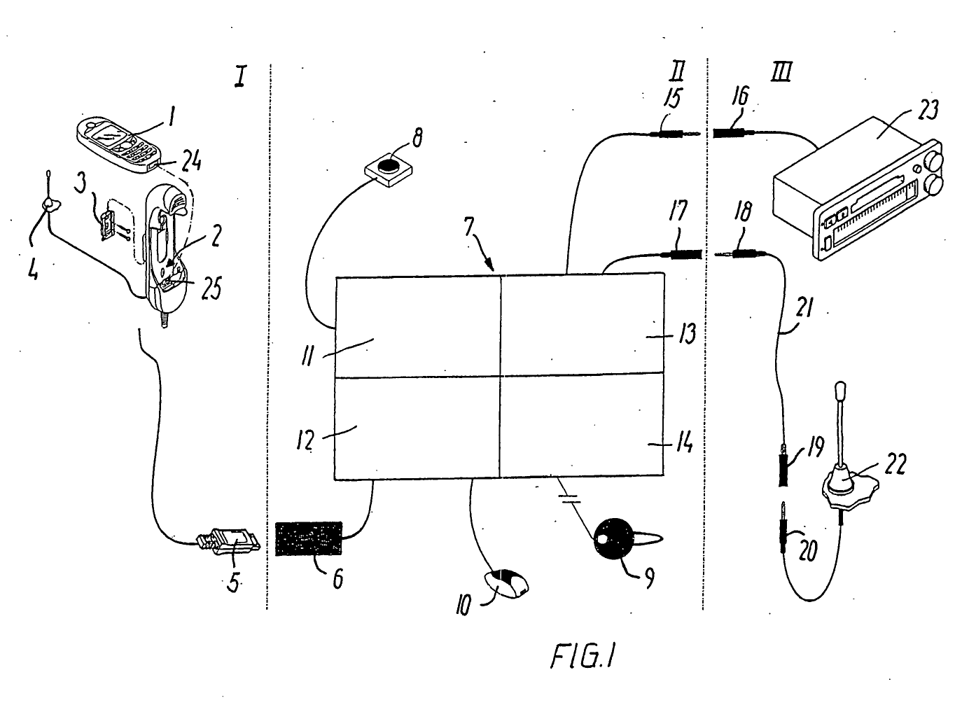

FIG. 1 shows the basic structure of a handsfree kit according to the invention, and

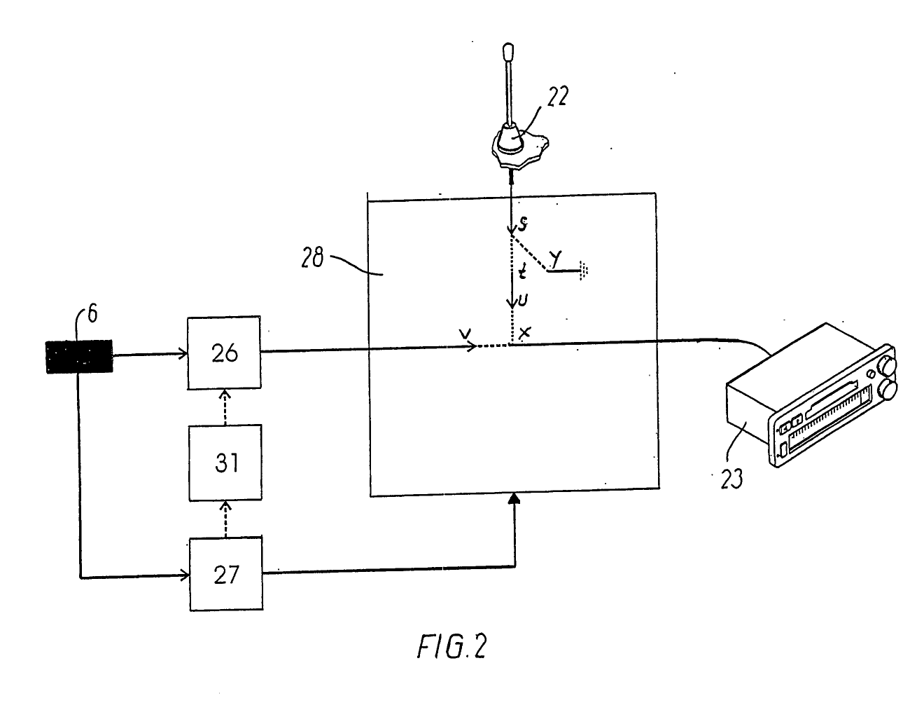

FIG. 2 shows how the prioritization of calls to the mobile telephone is carried out.

As will be seen in FIG. 1, it is divided into three sections, each of which is designated I, II, and III.

The first section contains a mobile telephone 1 which may be arranged in a telephone holder 2. The second section contains an electrical circuit 7 to which, as will be explained later, several units are connected, while the last section contains a car radio 23 which is connected inter alia to the electrical circuit 7.

The mobile telephone 1 may be placed in the telephone holder 2, which may generally be attached in a car (not shown) by means of a bracket 3.

The holder 2 may, although not necessarily, have coupled thereto an external microphone 4, which ensures optimum sound reproduction when the mobile telephone 1 is placed in the holder 2.

As will be seen in section II, the electrical circuit consists of four sub-circuits which are designated 11, 12, 13, and 14.

A switch 8 is connected to the sub-circuit 11, while a connector 6 is provided for the sub-circuit 12 to which a connector 5 with a wire, which is connected to the connector 25 of the telephone holder, may be connected. Generally, wire and connector may advantageously be replaced by a short range communications link, such as of the Bluetooth type.

For the sub-circuit 12, the mobile telephone 1 is connected via an electrical connector 24 to an electrical connector 25 in the telephone holder 2, so that communications signals may be transferred for processing in the circuit 7, as will be explained below.

It is also possible to charge the battery of the mobile telephone by means of the battery of the car, which is wired (not shown) to the holder 2.

Finally, a microphone 10, which may be arranged in the vicinity of the driver of a car, is connected to the sub-circuit 12.

For the sub-circuit 13, a connection to an antenna input on the shown car radio 23 in section III is established by means of the connectors 15 and 16 from an output on the sub-circuit 13.

Further, in section III there is shown an external antenna 22 which may be an antenna mounted on a car or in a window, normally a rear window. This antenna is coupled via connectors and wires 17, 18, 19, 20, and 21 to an antenna input on the sub-circuit 13.

Finally, the sub-circuit 13 performs an automatic switching function, so that the car radio or its connected units, such as CD or tape, are switched off when a call is received.

It will then be explained how the shown setup operates, it being assumed that three types of signal transfer to the loudspeakers of the car radio may occur in the setup, viz.
ordinary radio reception or playing of CD or tape,
RDS signal containing traffic messages or warnings,
telephone calls flanked by an RDS signal.

The circuit is designed in the manner that the sub-circuit 13 prioritizes the three types of signals such that a call to the mobile telephone will always have first priority over the other signals, while radio signals or signals from CD or tape will always have second priority. The system is arranged such that if the RDS function is switched off, the telephone signal can still be received.

The flexibility of the setup according to the invention also has the advantage that, without removing the mobile telephone 1 from the holder 2, the driver may conduct a private conversation, as he just has to affect the switch 8, following which calls are transferred to the headset, which may be coupled to the Bluetooth module.

In a further expedient embodiment, the headset may also be used for listening to the car radio or a CD or a tape, so that passengers avoid having to listen in, which may be an advantage when driving long distances at night, and especially if there are children in the car.

Some important functionalities of the setup are mentioned above, but, of course, it is also possible to adapt the setup to other wishes.

A headset 9 is connected to the sub-circuit 14, preferably by means of a short range communications link of the Bluetooth or DECT type. Further, a microphone 10 is connected to the sub-circuit 14.

The functions of the sub-circuits 11, 12, 13, and 14 will then be explained.

The sub-circuit 11 is a control circuit which allows switching of calls from the car radio 23 to the headset 9, it being possible for the user to make this switching merely by pressing the switch 8. The user may hereby rapidly change a conversation from being “available” to passengers in the car to being of a more private nature.

The sub-circuit 14 may be a Bluetooth radio module which provides the wireless connection to the headset 9.

The sub-circuit 12 is an interface circuit which makes it possible to adapt all the other sub-circuits 11, 13, and 14 to various mobile telephones, irrespective of type or make. For the sub-circuit 12, there may additionally be provided a connection to the battery of a car for powering the entire circuit 7 and for charging the mobile telephone 1.

The connector 6, the antenna 22 and the car radio 23 are also shown in FIG. 2. As will be seen in the:figure, the connector 6 is coupled to an FM modulator/mixer 26 and to a call detector. A signal is fed from an output of the call detector 27 to an RDS generator, which generates an RDS signal which is mixed with the FM signal in the FM modulator/mixer 26. Further, a signal is fed from an output of the call detector to a relay 28 adapted to switch the signals for the car radio between the FM modulator/mixer 26 and the antenna 22, and such that when a signal appears on the output of the FM modulator/mixer 26, then the antenna 22 will be connected to earth.

The relay 28 operates in the following manner:

For convenience, the terminals of the relay are designated s, t, u, v, x and y. When the car radio is in listen mode, the terminals s and t are connected, and the terminals u and x are connected. When a conversation is conducted through the mobile telephone, the terminals s and y and the terminals v and x are connected.

It will now be explained how the prioritization of calls to the mobile telephone is provided.

When a call is made to the mobile telephone, the audio signal is transferred to the connector 6 and fed further on to the FM modulator/mixer 26, where the audio signal is converted into an FM signal. The call detector 27 generates a control signal for the relay 28, which switches such that the antenna 22 is connected to earth, while the signal from the FM modulator/mixer 26, which has been mixed with an RDS signal, is transferred to the car radio 23. When the conversation has been terminated, the signal from the call detector 27 disappears, which causes the relay 28 to now connect the antenna 22 to the car radio 23, as explained above.

1. A handsfree kit for a mobile telephone (1), comprising a circuit coupled between the mobile telephone and a car radio (23) having a loudspeaker, said circuit being adapted to transfer information via a FM modulator/mixer (26) from the mobile telephone to the loudspeaker of the car radio at a call to the mobile telephone, irrespective of whether the car radio is in an active or a passive state, said circuit comprising an RDS generating circuit (31) which is connected to the FM modulator/mixer (26) via an antenna connector to an antenna input of the car radio, wherein the antenna connector consists of a relay (28) that is adapted to switch the signals for the car radio between the FM modulator/mixer (26) and an antenna (22) in such a way that when a signal appears on the output of the FM modulator/mixer (26), then the antenna will be connected to earth.

2. A handsfree kit according to claim 1, wherein the RDS generating circuit (31) is fed from an output from a call detector (27), said call detector being fed from an output from a connector (6) that is also connected to an input of the FM modulator/mixer (26).

3. A handsfree kit according to claim 1, wherein the circuit additionally has a control circuit which is coupled via an input to a switch for switching the calls of the mobile telephone between the car radio and a headset.

4. A handsfree kit according to claim 1, wherein the headset is wired or wirelessly connected to the circuit, e.g. via a short range communications link, such as Bluetooth or DECT.

5. A handsfree kit according to claim 1, wherein the circuit contains an interface circuit, which is connected to the mobile telephone through a mobile telephone holder.

6. A handsfree kit according to claim 5, wherein the interface circuit is connected to the mobile telephone holder via a short range communications link, such as of the Bluetooth type.
